(19) United States
(12) Patent Application Publication
(10) Pub. No.: US 2020/0057778 A1
(43) Pub. Date: Feb. 20, 2020

(54) DEPTH IMAGE POSE SEARCH WITH A BOOTSTRAPPED-CREATED DATABASE

(71) Applicant: Siemens Mobility GmbH, Munich (DE)

(72) Inventors: Shanhui Sun, Princeton, NJ (US); Stefan Kluckner, Berlin (DE); Ziyan Wu, Princeton, NJ (US); Oliver Lehmann, Schoeneiche bei Berlin (DE); Jan Ernst, Princeton, NJ (US); Terrence Chen, Princeton, NJ (US)

(21) Appl. No.: 16/603,347

(22) PCT Filed: Apr. 11, 2017
(86) PCT No.: PCT/US2017/026973

§ 371 Date: Oct. 7, 2019

(51) Int. Cl. G06F 16/535; G06F 16/538; G06F 16/583; G06N 3/08; G06N 3/04; G06K 9/62; G06T 7/73

(52) U.S. Cl. CPC G06F 16/535; G06F 16/538; G06F 16/5854; G06N 3/08; G06T 2207/30244; G06K 9/6215; G06T 7/74; G06T 2207/10028; G06T 2207/20081; G06N 3/04

(57) ABSTRACT

In pose estimation from a depth sensor (12), depth information is matched (70) with 3D information. Depending on the shape captured in depth image information, different objects may benefit from more or less pose density from different perspectives. The database (48) is created by bootstrap aggregation (64). Possible additional poses are tested (70) for nearest neighbors already in the database (48). Where the nearest neighbor is far, then the additional pose is added (72). Where the nearest neighbor is not far, then the additional pose is not added. The resulting database (48) includes entries for poses to distinguish the pose without overpopulation. The database (48) is indexed and used to efficiently determine pose from a depth camera (12) of a given captured image.

### BACKGROUND

The present embodiments relate to forming a database of entries with known poses for depth image searching. To augment an image from a depth camera, metadata from a corresponding 3D representation of the imaged objects may be added. To add the metadata, the coordinate systems of the depth camera and the 3D information are aligned. A pose of an object relative to a camera is found by searching the database. The comparison of depth camera data to 3D data may not be efficient for determining the pose.

In another approach, the depth camera image is compared to images in the database. The images in the database are of the object from different poses. The comparison finds the closest image of the database to the depth camera image, providing the pose. This approach suffers from having to create a large database, which is very cost intensive and laborious.

The image searching may itself be inefficient. Rather than a brute force search comparing images, pre-calculated image representations and indices are used. Even with more efficient indexing in the database and comparison of representations rather than the images themselves, the database may contain entries not needed or lack entries where needed. Regular pose sampling may not provide for efficient searching in the database for an object. The pose sampling for one object may not be appropriate for another object, so that the pose sampling may not efficiently sample the poses to best include in the database.

### SUMMARY

In various embodiments, systems, methods and computer readable media are provided for creating a database for pose estimation from a depth sensor, determining pose and/or matching depth information with 3D information. Depending on the shape captured in depth image information, different objects may benefit from more or less pose density from different perspectives. The database is created by bootstrap aggregation. Possible additional poses are tested for nearest neighbors already in the database. Where the nearest neighbor is far, then the additional pose is added. Where the nearest neighbor is not far, then the additional pose is not added. The resulting database includes entries for poses to distinguish the pose without overpopulation. The database is indexed and used to efficiently determine pose from a depth camera of a given captured image.

In a first aspect, a system is provided for matching depth information to 3D information. A depth sensor is for sensing 2.5D data representing an area of an object facing the depth sensor and depth from the depth sensor to the object for each location of the area. A memory is configured to store a database of entries representing the object from respective poses. The entries are populated in the database by iterative test of first matches of samples to the entries and adding the samples without matches as entries. An image processor is configured to search the entries of the database for a second match and to transfer an object label to a coordinate system of the depth sensor based on the second match. A display is configured to display an image from the 2.5D data augmented with the object label.

In a second aspect, a method is provided for creating a database for pose estimation from a depth sensor. A first plurality of poses of the depth sensor relative to a representation of an object are sampled. The poses of the first plurality are assigned to the database. A second plurality of poses of the depth sensor relative to the representation of the object are sampled. The nearest neighbors of the poses of the database with the poses of the second plurality are found. The poses of the second plurality are assigned to the database where the nearest neighbors are farther than a threshold and not assigning the poses of the second plurality to the database where the nearest neighbors are closer than the threshold. The sampling with a third plurality of poses, finding the nearest neighbors with the poses of the third plurality, and assigning the poses of the third plurality based on the threshold are repeated.

In a third aspect, a method is provided for creating a database for pose estimation from a depth sensor. A first plurality of different camera poses relative to an object are selected. Depth images of the object at the different camera poses of the first plurality are rendered.

The different camera poses of the first plurality are assigned to a database. Additional camera poses are added in a bootstrapping aggregation comparing depth images of the additional camera poses to the depth images of the camera poses of the database. The adding occurs when the comparing indicates underrepresentation in the database.

Any one or more of the aspects described above may be used alone or in combination. These and other aspects, features and advantages will become apparent from the following detailed description of preferred embodiments, which is to be read in connection with the accompanying drawings. The present invention is defined by the following claims, and nothing in this section should be taken as a limitation on those claims. Further aspects and advantages are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the embodiments. Moreover, in the figures, like reference numerals designate corresponding parts throughout the different views.

FIG. 1 is a flow chart diagram of one embodiment of a method for creating a database for pose estimation from a depth sensor;

FIG. 2 is a block diagram of one embodiment of a system for matching depth information to 3D information;

FIG. 3 illustrates one embodiment of a method for determining pose of an object relative to a camera; and

FIG. 4 is a flow chart diagram of one embodiment of a method for matching depth information to 3D information and/or determining pose.

### DETAILED DESCRIPTION OF EMBODIMENTS

A database is used for recognizing 6 degree-of-freedom (DOF) camera pose from a single 2.5D sensing image. The 6 DOF includes three axes of rotation and three axes of translation where translation of the depth camera towards or away from an object provides scale. The 2.5D depth image is matched to computer assisted design (CAD), medical volume imaging, geographic information system (GIS), building design, or other 3D information. The matching has interactive response times. Pose information supports fusion of the involved modalities within a common metric coordinate system. The 3D data may include metadata so that the spatial linking allows augmenting the mobile device image with the metadata. For example, spare part or organ specific information may be presented on a camera image at the appropriate location.

To find the correspondences, orthographic projections of the 3D data from potential viewpoints are created and/or stored in the database. These orthographic projections may be represented as 2.5D data structures or depth structures. The orthographic projections may be compared with the 2.5D data or depth structure of the 2.5D data for matching. Using these orthographic projections provides invariance to camera parameters

Typically, representations for CAD, GIS, engineering data, building design, or medical data are metric formats. Depth (e.g., RGBD) sensing devices provide metric 2.5D measurements for matching. To further reduce processing burden and/or increase matching speed, an indexing system for the orthographic projections may be used. Potentially relevant projections to the current scene observation are found based on the indexing. Rather than comparing spatial distribution of depths, the representations are compared, at least initially.

A fast and accurate 2.5D sensing image search uses a bootstrapped nearest neighbor indexing approach for the database. An effective searching database is built up a nearest neighbor indexing algorithm for searching camera pose based on image representation. To speed up the image search process, an indexing database is built. The indexing may be a KD-Tree to get a close-to log(n) searching efficiency, here n is the number of instance in the searching data base (KD-Tree). A fast library for approximate nearest neighbor (FLANN) may be used for such searches in high dimensional spaces.

The database entries contribute efficiency in this searching by limiting the number of entries while still sampling the possible poses sufficiently to provide accurate matching. The sufficient sampling may vary by object and/or poses relative to the object. Different objects may have different characteristics making it easier or less easy to match representations from different poses. A database with fewer entries to search, even with indexing, provides a more efficient and useful search. Where the entries are based on the object characteristics as reflected by the comparisons used to search, the efficiently searched database may be populated with sufficient entries to be accurate. By using bootstrapped nearest neighbor indexing, the entries are aggregated as needed. The image search-based approach using depth data is able to deploy a small database with more powerful searching capability, such as for accurate and fast spare part recognition.

The remaining portion of the Detailed Description is divided into two sections. The first section teaches rules used to build the database. These computer-specific rules for creating the database provide how to bootstrap aggregate entries to be used in the database specific to an object and/or the depth camera. The second section teaches rules for use of the database to provide metadata information. Due to the way in which the database is created, the use of the database is more efficient and/or accurate. The bootstrapping approach provides for a sampling of poses for the object by the camera that is sufficient to be accurate while avoiding excess sampling to maintain efficiency. The computer search operates more efficiently due to how the database is created.

### Creating the Database

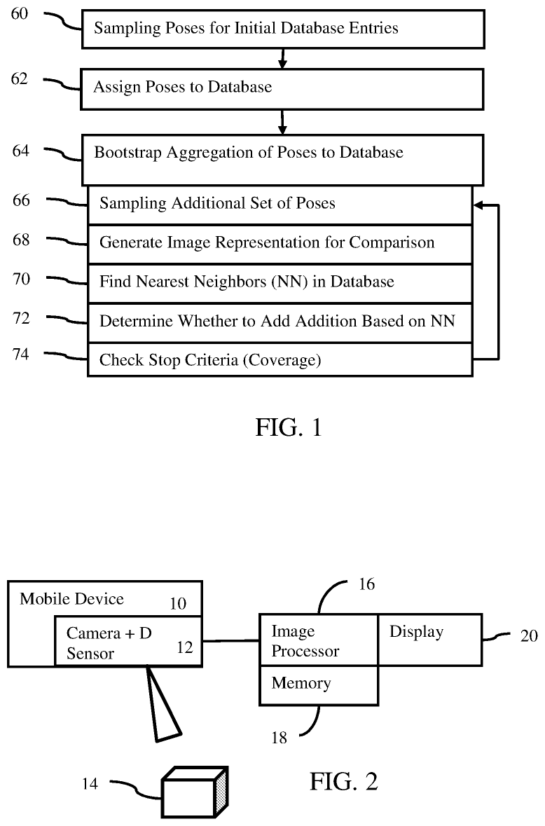

FIG. 1 shows one embodiment of a method for creating a database for pose estimation from a depth sensor. Bootstrapping is used to create the database. Based on a seed number of poses assigned to the database, additional poses are tested. Each additional pose is used to search the database. If close matches are found, then the additional pose is not added. If a close match is not found, then the additional pose is added. This process continues until sufficient coverage or other stop criterion is met, indicating that the database includes enough entries to provide a desired accuracy. The search-based testing avoids overpopulating the database.

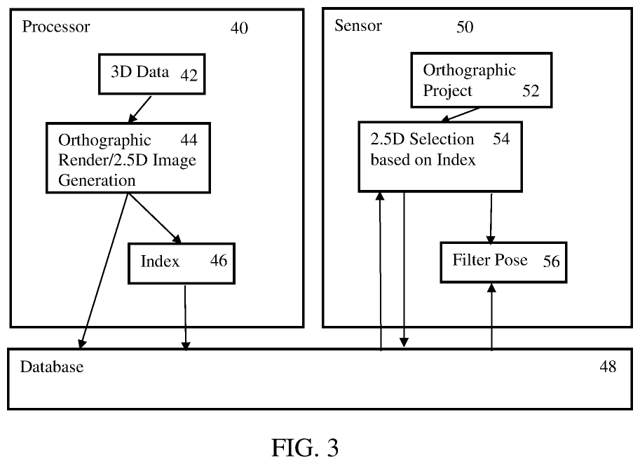

The method is performed by the system of FIG. 2, FIG. 3, the database processor 40, the image processor 16, or a different system or processor. For example, a database processor, such as a server, computer, workstation, or other processor for building a database, performs the acts. Other devices used include the database with the entries stored in an indexed manner for efficient searching, a memory with a representation of the object of interest, a renderer or image processor for rendering a depth image for a given pose, and/or a depth camera or memory with characteristics specific to a type or given depth camera.

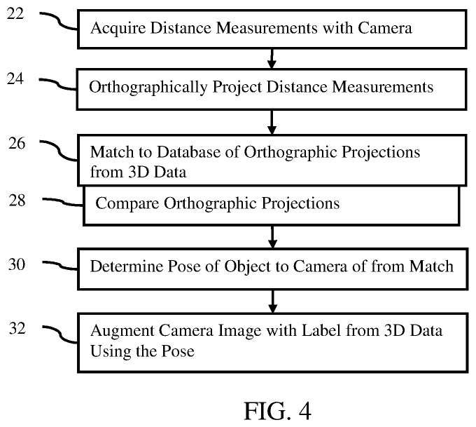

The method is performed in the order shown (top to bottom or numerical) or other order. For example, act 68 may also be performed before act 62 and 64. Additional, different, or fewer acts may be performed. For example, an act for generating image representations for poses sampled initially in act 60 is performed before act 62 or act 64. As another example, acts for indexing the database in a KD-tree, FLANN, or other index are provided. In yet another example, acts for using (e.g., see FIGS. 3 and 4) and/or acts for storing or transmitting the database are provided.

In act 60, a set of poses are sampled. The poses are of a depth sensor relative to an object. For creating the database, the depth sensor and object may be virtual. For example, synthetic data representing the object is used. A CAD, scan, engineering data, or other data represents the object in three dimensions. The object is posed by placing the camera at different locations relative to the object, and/or positioning the object at relative distances and orientations relative to the camera. This positioning may be virtual. Alternatively, an actual camera is positioned relative to an actual object for each pose.

Depending on the resolution and any limits, any number of poses are possible. For example, millions of possible poses are defined. The definition of the possibilities results in a super-set S of possible poses. This super-set may have duplicate, overlapping, or close poses. To use all the poses of the super-set S in the database would result in an inefficiently searchable database. Instead, the possible poses are used as a camera pose prior. The possible poses are sampled as discussed below.

The sampling is random, at least in some way. For example, a regular sampling over each of the six DOF is used, but the first pose or initial pose to define the sampling of the possible poses is randomly selected. A processor performs the random selection as user selection may not be sufficiently random. In another example, each sample of the possible poses is randomly selected. In yet another example, an initial pose is randomly selected or a default is used, but each subsequent selection is based on a random small pose perturbation (e.g., a small translation and/or rotation with randomness) from the previous pose. Other random selection approaches may be used. In an alternative embodiment, the different camera poses relative to the object are selected programmatically, such as with default or pre-defined sampling.

The sampling is for an initialization of the database. The sampling provides poses to be included in the database as a starting point. Any number, n₁, of poses may be used, such as 5,000 poses out of hundreds of thousands or millions of possible poses.

In act 62, the selected poses for the initial sampling are assigned to the database. The different camera poses relative to the object from the selected set, n₁, populate the database. As an initial starting point, no other poses are included. In alternative embodiments, the n₁ poses include other poses for initializing the database, such as including any number of default or user set poses.

Each pose assigned to the database provides for an entry in the database. Other information may be included for each entry, such as an image representation (e.g., a searchable signature for the 2.5D data at the pose) and metadata. The metadata may be pose parameters, patch information, camera information (e.g., focal length), annotation information, reference to an original 3D dataset, coordinate transform, and/or other information. The patch information may be a division of the image representation used for searching.

The initial database includes n₁ poses. This initial database is or is to be indexed for searching to test whether to add additional poses. In act 64, the database processor adds additional camera poses in a bootstrapping aggregation. In an automated approach using rules, the database processor determines additional poses to be added to the database and additional poses not to be added. The determination is based on search results from database searching performed by the database processor. In this way, entries are added to the database based on the object and/or camera of interest while limiting the size of the database for efficient searching by a processor.

In general, the bootstrapping aggregation compares depth images of additional camera poses to the depth images of the camera poses of the database. The addition occurs when the comparison indicates underrepresentation of pose in the database. The additional pose is not added when the comparison indicates close representation in the database. This iterative approach continues until a stop criterion is satisfied.

Acts 66-74 are one embodiment for the bootstrapped aggregation of entries for the database. Additional, different, or fewer acts may be included.

In act 66, the possible poses are sampled to create another sub-set. This additional sub-set is exclusive of poses already in the database or may include some of the poses already in the database. The additional poses represent the depth sensor relative to the representation of the object.

The same or different sampling as used in act 60 is provided. For example, the sampling is random, at least to some extent. In one approach, the database processor randomly chooses all the additional samples from the possible poses or possible poses without poses already in the database. In another approach, the database processor choses one or more additional poses and then choses other additional poses based on randomized perturbations in translation and/or orientation.

The additional poses are chosen as a test batch. Rather than choosing one additional pose to test in each iteration, multiple additional poses are chosen, allowing calculation of a population-based stop criterion. For example, 1,000 additional poses are selected in a batch. The database processor acquires n₂ additional poses. The number, n₂, is less than the number of poses in the database (e.g., n₁), but may be the same or more. In alternative embodiments, n₂ is one.

In act 68, the database processor or other renderer (e.g., graphics processing unit, server, or workstation) generates image representations of the object at the poses. The image representation is a signature of the depth image at that pose. The signature may be searched or compared with other signatures to determine whether the compared signatures represent a same pose and/or depth image.

Rather than generating the image representation for all the possible poses, the image representations are generated for the poses in the database and the additional poses to be tested relative to the database (i.e., the n₁ and n₂ poses).

Any timing may be used. For example, the image representations for the n₁ poses in the database are created when the poses are assigned or added to the database, and the image representations for the n₂ additional poses are created as needed for comparison and/or upon selection. In another example, the image representation for any of the poses are created for an initial use. If the pose is in the database or to be assigned to the database, then the image representation may stored as part of the entry in the database or may be added when needed.

The image representation may be a 2.5D data set or depth image. Where the object is represented by 3D data, the 3D data is rendered or projected to form 2.5D data. For example, an orthographic projection is performed on CAD data to create a depth image simulation of capture by a depth camera. Example orthographic projections are discussed below in the use of the created database section. Depth images are rendered at the different camera poses relative to the object.

In one embodiment, the amount of data in the image representation is reduced for more efficient searching. For example, a histogram or other approach discussed below in the use of the created database section is used. As another example, the image representation is learnt from synthetic 2.5D image of a CAD model using a convolution neural network (deep learning). Deep learning is used to determine features of the 2.5D data or depth image that indicate pose. For example, one hundred features are determined by the deep learning by the database processor training a convolutional neural network on depth images with known poses. Values for the features for each depth image of the poses of the database are calculated. The deep learnt-based image representation is stored for comparison as a signature.

In act 70, the database processor searches the database for matches to the additional poses. The image representation of each additional pose is used to search the image representations of the poses in the database.

The search is the same or different than searching used in applying the created database. In one embodiment, the entries in the database are indexed, such as with FLANN, KD-tree, another tree search, or another database index search appropriate for image representations from depth images. By indexing, an approximate log(n) search efficiency may be provided, where n is the number of entries in the database. Alternatively, a brute force search comparing to every entry is used.

Using the index or other search pattern, the similarity of the image representation of the additional pose to one or more image representations of poses in the database is measured. The search measures of similarity. For example, a nearest neighbor search based on the values for deep-learnt or other machine-learnt features is performed.

The search identifies the most similar image representation in the database. For example, the nearest neighbor is found. Any number of nearest neighbors or similar entries may be identified. For example, the database processor identifies only 1, 2, 3, or more most similar image representations for the image representation of each additional pose of the test set. For finding one nearest neighbor, n₂ database queries from the created database are performed (e.g., search for the nearest neighbor of each additional pose). Where k is a number of nearest neighbors or most similar poses being sought, the results of the search are n₂*k poses. In the example with n2 is 1,000, then k=1 returns one image representation from the database for each additional pose, so provides 1,000 nearest neighbors. In this example with k=3, the search provides 3,000 nearest neighbors, three for each additional pose.

In act 72, the database processor determines whether to add the additional pose to the database. Some of the additional poses may be added and others not added. All the additional poses may be added, or all the additional poses not added. The addition is of an entry in the database, so the signature (e.g., image representation) with or without the 2.5D data and metadata for the selected additional pose are added. The assignment of the additional poses to the database increases the number of entries in the database.

The search results are used to determine whether to assign. The pose from the match or matches in the database is compared to the known pose for the additional pose. The comparison uses a threshold. The threshold is set by the user and/or is a default. The threshold establishes the pose resolution to be used in the database, so may affect the accuracy.

The difference in pose is calculated and compared to the threshold. For example, a distance in location between the poses is calculated. As another example, a difference in angle or vector difference between the poses is calculated. In yet another example, a distance and difference in angle are both calculated. Separate thresholds are provided for the translation and orientation. Any combination, such as a weighted combination, of differences from thresholds may be used.

If the difference in translation and/or orientation is larger than the threshold, then the additional pose is added to the database. The larger difference indicates that the database does not include a similar pose (i.e., the search result is far from the ground truth of the additional pose), so the hole in the database is filled based on the test results.

If the difference in translation and/or orientation is smaller than the threshold, then the additional pose is not added to the database. The smaller difference indicates that the database already has a similar pose, so the additional pose (even if different) is not added to maintain efficiency in searching.

For a given additional pose, the search identifies one or more entries in the database. For k=1, 1 pose from the database is identified. In this case, the thresholding is for the one comparison. For k=3, 3 poses from the database are identified. In this case, 3 comparisons are made, the ground truth pose of the additional pose is compared to the poses of the 3 nearest neighbors from the database. If any of the comparisons show a similar pose already in the database, then the additional pose is not added. If all the comparisons show a similar pose not in the database, then the additional pose is added.

The decision to add is performed for each of the additional poses. For the n₂ additional poses, then n₂ decisions are made. A sub-set x of the n₂ additional poses may be added. n₂−x additional poses are not added.

In act 74, the database processor checks the stop criterion or criteria for building the database. The addition by batches is performed iteratively or repetitively until a stop criterion indicates ceasing of adding poses to the database.

Any stop criterion or criteria may be used. In one embodiment, a measure of coverage for the database is used. To provide the desired accuracy, the database includes sufficient entries to provide a desired coverage of the possible poses while avoiding duplicating entries. Other measures than coverage may be used, such as having tested a given number or percentage of the possible poses. Another measure is the number of entries in the database. If the number of entries in the indexing database is greater than certain threshold, no additional poses are added. Combinations of criteria may be used, such as ceasing only when two or more criteria are met or ceasing when any one of multiple criteria are met.

Any measure of coverage may be used. In one approach, the batch processing of additional poses is used to calculate the coverage. A percentage of the number, n2, of additional poses in each batch are added. Where the percentage is low, then the coverage is good. A threshold for coverage based on the percentage may be used. For example, a ratio of a number of the additional poses assigned to the database to a number of the poses of the batch of additional poses for the iteration is calculated. This ratio may be expressed as x/n₂. This ratio is subtracted from 1 to provide the coverage (e.g., coverage=1.0−(number of newly added poses to the Database/n₂). Alternatively, the coverage is the ratio. If the coverage is greater than a threshold, the testing of additional poses ceases.

The stop criterion may require repetition. Where the stop criterion is satisfied a given number iterations (e.g., two or three times in a row), then the stop criterion is satisfied. Given a randomized sampling, the repeated coverage above the threshold more likely provides for actual coverage. Alternatively, the iteration ceases upon the first instance of coverage above the threshold.

When the stop criterion or criteria are not satisfied, then the bootstrapping aggregation continues. The feedback arrow from act 74 to act 66 represents repeating the sampling of act 66 for another batch of additional poses, generating image representations for this additional batch in act 68, finding the nearest neighbors of the additional poses with the poses in the updated database in act 70, assigning any number of these further additional poses to update the database in act 72, and then checking the stop criterion or criteria for this further batch in act 74. Any number of repetitions are performed, adding at least some of the additional poses of each batch to update the database. The iterations or repetition for additional batches of additional poses sampled from the possible poses continues until the stop criterion or criteria are satisfied.

Once the updating ceases, a database ready for use is provided. The database is an effective indexing database with significantly smaller number of entries than the number of possible poses. Due to the search-based testing for determining whether to add a pose to the database, the database provides optimized entries for fast and robust image search with real 2.5D sensing data.

### Using the Database

The created database is used to determine a pose of an actual object captured by an actual depth sensor. In embodiments discussed below, using the created database provides for accurate and efficient searching to determine the pose of the object represented in a depth image captured by the depth camera. The orthographic projections, indexing, and/or image representations discussed below may be used. Alternatively, other orthographic projections, indexing, and/or image representations are used with the created database. In one embodiment, utilizing bootstrapped nearest neighbor indexing for the database with deep learning representation-based approach overcomes limitations of the sensor and fully utilizes imaging characteristics.

FIG. 2 shows one embodiment of a system for matching depth information to 3D information, pose determination, and/or aligning coordinate systems. In general, the mobile device 10 captures 2.5D data of the object 14. To determine the pose of the object in the captured 2.5D data (relative to the camera), the depth information of the 2.5D data is compared to orthographic projections from different viewpoints. The orthographic projections are generated from 3D data representing the object and stored in a database. For example, the database is populated using the creation discussed above. The comparison may be simplified by using histograms of the depths, machine-learnt feature values or other representation derived from the orthographic projections. The pose is determined from the pose or poses of the best or sufficiently matching orthographic projections from the database.

The system includes a mobile device 10 with a camera and depth sensor 12 for viewing an object 14, an image processor 16, a memory 18, and a display 20. The image processor 16, memory 18, and/or display 20 may be remote from the mobile device 10. For example, the mobile device 10 connects to a server with one or more communications networks. As another example, the mobile device 10 connects wirelessly but directly to a computer. Alternatively, the image processor 16, memory 18, and/or display 20 are part of the mobile device 10 such that the matching and augmentation are performed locally or by the mobile device 10.

Additional, different, or fewer components may be provided. For example, a database separate from the memory 18 is provided for storing orthographic projections or representations of orthographic projections of the object from different viewpoints. As another example, other mobile devices 10 and/or cameras and depth sensors 12 are provided for communicating depth data to the image processor 16 as a query for pose. In another example, a user input device, such as a touch screen, keyboard, buttons, sliders, touch pad, mouse, and/or trackball, is provided for interacting with the mobile device 10 and/or the image processor 16.

The object 14 is a physical object. The object 14 may be a single part or may be a collection of multiple parts, such as an assembly (e.g., machine, train bogie, manufacturing or assembly line, consumer product (e.g., keyboard or fan), buildings, or any other assembly of parts). The parts may be separable or fixed to each other. The parts are of a same or different material, size, and/or shape. The parts are connected into the assembled configuration or separated to be assembled. One or more parts of an overall assembly may or may not be missing. One or more parts 16 may themselves be assemblies (e.g., a sub-assembly). In other embodiments, the object 14 is a patient or animal. The object 14 may be part of a patient or animal, such as the head, torso, or one or more limbs. Any physical object may be used.

The object 14 is represented by 3D data. For example, a building, an assembly, or manufactured object 14 is represented by computer assisted design data (CAD) and/or engineering data. The 3D data is defined by segments parameterized by size, shape, and/or length. Other 3D data parameterization may be used, such as a mesh or interconnected triangles. As another example, a patient or inanimate object is scanned with a medical scanner, such as a computed tomography, magnetic resonance, ultrasound, positron emission tomography, or single photon emission computed tomography system. The scan provides a 3D representation or volume of the patient or inanimate object. The 3D data is voxels distributed along a uniform or non-uniform grid. Alternatively, segmentation is performed, and the 3D data is a fit model or mesh.

The 3D data may include one or more labels. The labels are information other than the geometry of the physical object. The labels may be part information (e.g., part number, available options, manufacturer, recall notice, performance information, use instructions, assembly/disassembly instructions, cost, and/or availability). The labels may be other information, such as shipping date for an assembly. The label may merely identify the object 14 or part of the object 14. For the medical environment, the labels may be organ identification, lesion identification, derived parameters for part of the patient (e.g., volume of a heart chamber, elasticity of tissue, size of a lesion, scan parameters, or operational information). A physician or automated process may add labels to a pre-operative scan and/or labels are incorporated from a reference source. In another example, the label is a fit model or geometry.

The mobile device 10 is a cellular phone, tablet computer, the camera and depth sensor 12, navigation computer, virtual reality headgear, glasses, or another device that may be carried or worn by a user. The mobile device 10 operates on batteries rather than relying on a cord for power. In alternative embodiments, a cord is provided for power. The mobile device 10 may be sized to be held in one hand, but may be operated with two hands. For a worn device, the mobile device 10 is sized to avoid interfering with movement by the wearer. In other alternatives, the camera and depth sensor 12 is provided on a non-mobile device, such as a fixed mount (e.g., security or maintenance monitoring camera).

The camera and depth sensor 12 is a red, green, blue, depth (RGBD) sensor or other sensor for capturing an image and distance to locations in the image. For example, the camera and depth sensor 12 is a pair of cameras that use parallax to determine depth for each pixel captured in an image. As another example, lidar, structured light, or time-of-flight sensors are used to determine the depth. The camera portion may be a charge coupled device (CCD), digital camera, or other device for capturing light over an area of the object 14. In other embodiments, the camera and depth sensor 12 is a perspective camera or an orthographic 3D camera.

The camera portion captures an image of an area of the object 14 from a viewpoint of the camera and depth sensor 12 relative to the object 14. The depth sensor portion determines a distance of each location in the area to the camera and depth sensor 12. For example, a depth from the camera and depth sensor 12 to each pixel or groups of pixels is captured. Due to the shape and/or position of the object 14, different pixels or locations in the area may have different distances to a center or corresponding cell of the camera and depth sensor 12. The 2.5D data represents a surface of the object 14 viewable from the RGBD sensor and depths to parts of the object 14. The surface or area portion (e.g., RGB) is a photograph.

The camera and depth sensor 12 connects (e.g., wirelessly, over a cable, via a trace) with an interface of the image processor 16. Wi-Fi, Bluetooth, or other wireless connection protocol may be used. In alternative embodiments, a wired connection is used, such as being connected through a back plane or printed circuit board routing.

In a general use case represented in FIG. 2, a user captures 2.5D data of the object 14 from a given orientation relative to the object 14 with the camera and depth sensor 12. The 2.5D data includes a photograph (2D) of the area and depth measurements (0.5D) from the camera and depth sensor 12 to the locations represented in the area. The distance from the camera and depth sensor 12 to obscured portions (e.g., back side) of the object 14 are not captured or measured, so the 2.5D data is different than a 3D representation of the object 14. 2.5D images may be seen as a projection of 3D data onto a defined image plane. Each pixel in 2.5D images corresponds to a depth measurement and light intensity. The mapped and visible surface may be recovered from the 2.5D data. The depth measurements in combination with the camera parameters allows the 2.5D image representation to be converted to a 3D point cloud, where the camera center is typically assumed to be at the origin. Depending on the sensing technology, the collected data includes noise or can suffer from missing data, which makes an estimation of topology challenging. RGB information is typically available and provides visual scene observation.

The 2.5D may be captured at any orientation or in one of multiple defined or instructed orientations. Any position (i.e., translation) relative to the object is used. The 2.5D data is communicated to the image processor 16. Upon arrival of the 2.5D data (e.g., photograph and depth measurements) or stream of 2.5D data (video and depth measurements), the image processor 16 returns one or more labels, geometry, or other information from the 3D data to be added to a display of an image or images (e.g., photograph or video) from the 2.5D data. The arrival of 2.5D data and return of labels occurs in real-time (e.g., within 1 second or within 3 seconds), but may take longer.

From the camera operator's perspective, a photograph or video is taken. Label information for one or more parts in the photograph is returned, such as providing smart data, and displayed with the photograph. Due to the short response time to provide the label, the operator may be able to use the smart data to assist in maintenance, ordering, diagnosis, or other process. For more complex objects 14, the user may be able to select a region of interest for more detailed identification or information. The image processor 16 interacts with the operator to provide annotations for the photograph from the 3D data.

For matching the 2.5D data with the 3D data, the depth cues are used rather than relying just on the more data intensive processing of texture or the photograph portion. The depth cue is used as a supporting modality to estimate correspondence between the current view of the mobile device 10 and the 3D data.

The camera and depth sensor 12 provide the 2.5D data, and the memory 18 provides the database created from the 3D data and/or information derived from the 3D data. The memory 18 is a database, a graphics processing memory, a video random access memory, a random access memory, system memory, cache memory, hard drive, optical media, magnetic media, flash drive, buffer, combinations thereof, or other now known or later developed memory device for storing data or video information. The memory 18 is part of the mobile device 10, part of a computer associated with the image processor 16, part of a database, part of another system, a picture archival memory, and/or a standalone device. The memory 18 is configured by a processor to store, such as being formatted to store.

The 3D information includes surfaces of the object 14 not in view of the camera and depth sensor 12 when sensing the 2.5D data. 3D CAD is typically represented in 3D space by using XYZ coordinates (vertices). Connections between vertices are known—either by geometric primitives like triangles/tetrahedrons or more complex 3D representations composing the 3D CAD model. CAD data is clean and complete (watertight) and does not include noise. CAD data is generally planned and represented in metric scale. Engineering or GIS data may also include little or no noise. For medical scan data, the 3D data may be voxels representing intensity of response from each location. The voxel intensities may include noise. Alternatively, segmentation is performed so that a mesh or other 3D surface of an organ or part is provided.

The memory 18 stores the 3D data and/or information derived from the 3D data. For example, the memory 18 stores orthographic projections of the 3D information. An orthographic projection is a projection of the 3D data as if viewed from a given direction. The orthographic projection provides a distance from the viewable part of the object to a parallel viewing plane. The camera center of the orthographic projection may point to a point of interest (e.g. the center of gravity of the observed object). A plurality of orthographic projections from different view directions relative to the object 14 are generated and stored. Different translations or positions of the simulated camera to the simulated object may be used. To enable the correspondence estimation between 2.5D depth images and 3D data, a 2.5D image database is created based on the 3D data. The database may be enriched with “real world” data acquisitions, such as measurements, models or images used to remove or reduce noise in the 3D data.

During database creation, the 3D CAD model or 3D data is used to render or generate synthetic orthographic views from any potential viewpoint a user or operator may look at the object 14 in a real scene. Where the object 14 is not viewable from certain directions, then those viewpoints may not be used. The strategy for creating synthetic views may be random or may be based on planned sampling the 3D space (e.g., on sphere depending on the potential acquisition scenario during the matching procedure). Any number of viewpoints and corresponding distribution of viewpoints about the object 14 may be used. The orthographic projections from the 3D data represent the object from the different view directions.

The orthographic projections are normalized to a given pixel size. To be invariant to camera characteristics and scale, the synthetic database is created based on orthographic projections where each resulting pixel in the 2.5D orthographic projections (i.e., depth information) provides a same size (e.g., 1 pixel corresponds to a metric area, such as 1 pixel maps to 1×1 inch in real space). In alternative embodiments, the projections are not normalized, but instead a pixel area is calculated and stored with each projection.

In addition or as an alternative to storing the orthographic projections themselves, other representations of the orthographic projections are stored. The orthographic projections are indexed, such as with histograms. The orthographic projections are used to create a representative dataset that can be used for indexing. The efficient indexing system allows filtering for potentially similar views based on the set of created 2.5D views and reduction of the search space during the matching procedure.

In one embodiment, each orthographic projection is mapped to a histogram representation. The histogram is binned by depths, so reflects a distribution of depths without using the photographic or texture information. The spatial distribution of the depths is not used. To enable a quick search on the database images (e.g., reference images derived from the 3D data), an indexing system inspired by a Bag-of-Word concepts is applied to the orthographic projections and its histogram representation. A histogram driven quantization of the depth is used due to efficiency during generation. Due to restricted depth ranges, a quantization of depth values into specified number of bins is used. Noisy measurement can be filtered in advance, such as by low pass, mean, or other non-linear filtering of the depths over the area prior to binning. In other embodiments, the orthographic projections are mapped to a descriptor using a neural network or deep learnt classifier.

Instead of using the entire pixel information of each 2.5D image, the pre-filtering for similar views is only done based on a compact histogram representation for each generated view. Histogram representations over depth measurements also overcome the problem of missing data since normalized 1D distributions may be generated for image regions with holes. For robustness, a histogram representation in a coarse to fine concept (i.e. creating a spatial pyramid of histograms) may be used.

Other representations than histograms may be used to create an indexed database. For example, values of machine-learnt features are stored. After training, a deep learnt classifier provides kernels or other features. The learnt features are applied to the orthographic projections to determine values for distinguishing pose. These values are calculated for each orthographic projection, providing values as a representation for each pose.

In one embodiment, the database of orthographic projections and/or other representations from different poses is created using the bootstrapping discussed above. Each entry in the database corresponds a different pose of the object. The database is populated with entries of projection and/or representation of the object by iterative testing of batches. Possible entries are tested to the already existing entries. Random selection may be used to determine which possible entries to test. An image representation is generated for each entry being tested. A search is performed. If the search finds a sufficiently close (e.g., based on a threshold or thresholds) match, then the entry being tested is not added. If the search does not find sufficiently close match, then the entry being tested is added to the database. This testing continues until a stop criterion or criteria are met, such as sufficient coverage (e.g., threshold amount of coverage) results. Once populated, the database includes image representations from many different poses selected based on matching for that object.

The memory 18 also stores labels and coordinates for the labels. The label information may be stored separately from the 3D data. Rather than store the 3D data, the orthographic projections and/or image representations and label information are stored.

The memory 18 or other memory is alternatively or additionally a non-transitory computer readable storage medium storing data representing instructions executable by the programmed image processor 16 for matching 2.5D and 3D data to determine pose and/or to create the database. The instructions for implementing the processes, methods and/or techniques discussed herein are provided on non-transitory computer-readable storage media or memories, such as a cache, buffer, RAM, removable media, hard drive or other computer readable storage media. Non-transitory computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instructions set, storage media, processor or processing strategy and may be performed by software, hardware, integrated circuits, firmware, micro code and the like, operating alone, or in combination. Likewise, processing strategies may include multiprocessing, multitasking, parallel processing, and the like.

In one embodiment, the instructions are stored on a removable media device for reading by local or remote systems. In other embodiments, the instructions are stored in a remote location for transfer through a computer network or over telephone lines. In yet other embodiments, the instructions are stored within a given computer, CPU, GPU, or system.

The image processor 16 is a general processor, central processing unit, control processor, graphics processor, digital signal processor, three-dimensional rendering processor, server, application specific integrated circuit, field programmable gate array, digital circuit, analog circuit, combinations thereof, or other now known or later developed device configured for processing image data (e.g., 2.5D data and 3D data). The image processor 16 is for searching an index, matching orthographic projections, aligning coordinates, and/or augmenting displayed images. The image processor 16 is a single device or multiple devices operating in serial, parallel, or separately. The image processor 16 may be a main processor of a computer, such as a laptop or desktop computer, or may be a processor for handling some tasks in a larger system, such as in the mobile device 10. The processor 16 is configured by instructions, design, hardware, and/or software to perform the acts discussed herein.

The image processor 16 is configured to relate or link 3D data (e.g., engineering data) with the real world 2.5D data (e.g., data captured by the camera and depth sensor 12). To relate, the pose of the object 14 relative to the camera and depth sensor 12 is determined. Using orthographic projections, the image processor 16 outputs labels specific to pixels or locations of the object displayed in a photograph or video from the 2.5D data. The pose is determined by matching with different poses stored in the memory 18.

The 2.5D data is converted to or used as an orthographic projection of the object 14. The depth measurements are extracted from the 2.5D data, resulting in the orthographic projection. The depth measurements provide for depth as a function of location in an area. During the matching, the depth stream of the observed scene (e.g., 2.5D data) is converted to an orthographic representation. The depth measurements from the 2.5D data may be compared with the depth measurements of the orthographic projections from the 3D data. Alternatively, another image representations from the 2.5D data are compared with image representations of the orthographic projections from the 3D data.

The orthographic projection from the 2.5D data is scaled to the pixel size used for the orthographic projections from the 3D data. The size of the pixels scales to be the same so that the depth measurements correspond to the same pixel or area size. The focal length and/or other parameters of the camera and depth sensor 12 as well as the measured depth at the center of the area are used to scale.

Once scaled, the orthographic projection from the 2.5D data is matched with one or more orthographic projections from the 3D data. To estimate the spatial correspondence between the modalities (i.e., camera and depth sensor 12 and the source of the 3D data), the orthographic projections are matched. The orthographic projection from the 2.5D data is compared to any number of the other orthographic projections in the database. A normalized cross-correlation, minimum sum of absolute differences, or other measure of similarity may be used to match based on the comparison. These comparisons may be efficiently computed on architectures for parallelization, such as multi-core processors and/or graphics processing units. A threshold or other criterion may be used to determine sufficiency of the match. One or more matches may be found. Alternatively, a best one or other number of matches are found.

To reduce the processing for matching, other image representations may be matched. The orthographic projection from the 2.5D data or the 2.5D data is converted to a histogram (2.5D depth histogram), machine-learnt feature values, or other image representation. The entries in the database are likewise stored with the same image representation. The 2.5D depth image representation is then matched to the index of image representations for the 3D data. The same or different types of matching discussed above may be used. For example, normalized cross correlation based on box filters or filtering in the Fourier domain finds similar views. FLANN may be used. By comparing the 2.5D image representation with the 3D image representations, the 3D image representations sufficiently matching with the 2.5D image representation are found. The image representations are used to match the orthographic projections. The image representations of the index are an intermediate image representation for finding the most similar views to the current measurement.

The orthographic projection quantized into a different image representation may enable a quick search for potentially similar views in the database. By comparing image representations, the amount of image processing is more limited. The spatial distribution of the depths is removed.

The search for matches may follow any pattern, such as testing each entry. In one embodiment, a tree structure or search based on feedback from results is used. The 3D image representations are clustered based on similarity so that branches or groupings may be ruled out, avoiding comparison with all the image representations. For example, a tree structure using L1/L2 norms or approximated metrics are used.

The image processor 16 is configured to determine a pose of the object 14 relative to the camera and depth sensor 12 based on poses of the object 14 in the 3D orthographic projections. Where a best match is found, the pose of the orthographic projection or representation derived from the 3D data is determined as the pose of the object 14 relative to the camera and depth sensor 12. By using orthographic projections as the basis for matching, the pose is determined with respect to natural camera characteristics. By using image representations derived from the orthographic projections, the comparison of the orthographic projections may be more rapidly performed.

In other embodiments, the pose or poses from the matches are further refined to determine a more exact pose. A refined filter strategy may result in more accurate pose recovery. A plurality of matches is found. These matches are of similar views or poses. The similar views are feed into the refined filtering strategy where the 3D-based orthographic images are matched to the current template or 2.5D-based orthographic image. The comparison of image representations is performed as discussed above. This filtering concept or comparisons of image representations provides a response map encoding potential viewpoints. The response map is a chart or other representation of the measures of similarity. A voting scheme is applied to the most similar views. Any voting scheme may be used, such as selecting the most similar, interpolating, Hough space voting, or another redundancy-based selection criterion. The voting results in a pose. The pose is the pose of the selected (i.e., matching) orthographic projection or a pose averaged or combined from the plurality of selected (i.e., matching) orthographic projections.

The image processor 16 may further refine the pose of the object relative to the camera and depth sensor 12. The refinement uses the features in the orthographic projections rather than the image representation. The 3D-based orthographic projection or projections closest to the determined pose are image processed for one or more features, such as contours, edges, T-junctions, lines, curves, and/or other shapes. In alternative embodiments, the features from the 2.5D data are compared to features from the 3D data itself. The 2.5D orthographic projection is also image processed for the same features.

The features are then matched. Different adjustments of the pose or orientation are made, resulting in alteration of the features for the 3D orthographic projection. The spatial distribution of the features is compared to the features for the matching 2.5D orthographic projection. The alteration to the pose providing the best match of the features is the refined pose estimate.

Once the pose is determined, the spatial relationship of the 2.5D data to the 3D data is known. Coordinates in the 3D data may be related to or transformed to coordinates in the 2.5D data. The coordinate systems are aligned, and/or a transform between the coordinate systems is provided.

The image processor 16 is configured to transfer an object label of the 3D data and corresponding source to a coordinate system of the camera and depth sensor 12 based on the match. The recovered pose of the mobile device 10 with respect to the 3D data enables the exchange of information, such as the labels from the 3D data. For example, part information or an annotation from the 3D data is transferred to the 2.5D data.

The object label is specific to one or more coordinates. Using the aligned coordinate systems or the transform between the coordinate systems, the location of the label relative to the 2.5D data is determined. Labels at any level of detail of the object 14 may be transferred.

The transfer is onto an image generated based on the 2.5D data. For example, the image processor 16 transfers a graphical overlay or text to be displayed as a specific location in an image rendered from or based on the photographic portion of the 2.5D data.

The display 20 is a monitor, LCD, projector with a screen, plasma display, CRT, printer, touch screen, virtual reality viewer, or other now known or later developed devise for outputting visual information. The display 86 receives images, graphics, text, quantities, or other information from the camera and depth sensor 12, memory 18, and/or image processor 16. The display 20 is configured by a display plane or memory. Image content is loaded into the display plane, and then the display 20 displays the image.

The display 20 is configured to display an image from the 2.5D data augmented with the object label from the 3D information. For example, a photograph or video of the object 14 is displayed on the mobile device 10. The photograph or video includes a graphic, highlighting, brightness adjustment, or other modification indicating further information from the object label or labels. For example, text or a link is displayed on or over part of the object 14. In one embodiment, the image is an augmented reality image with the object label being the augmentation rendered onto the image. Images from the 2.5D data are displayed in real-time with augmentation from the 3D data rendered onto the photograph or video.

In alternative embodiments, the display 20 displays the augmentation on a screen or other device through which the user views reality. Rather than augmenting a photograph, the actual view is augmented. The camera and depth sensor 12 may be a depth sensor used to determine the user's current viewpoint.

Various applications may benefit. The proposed approach enables the transfer of object labels into the coordinate system of the observed scene and vice versa. Annotations or part information for part of the object 14 are transferred and rendered as an augmentation. The proposed approach may be used for initialization of a real-time tracking system during augmented reality processing. Tracking may use other processes once the initial spatial relationship or pose is determined.

In one embodiment, the object label being transferred is part information for part of the object as an assembly. For example, the part may be automatically identified. The user takes a picture of the object 14. The returned label for a given part identifies the part, such as by matching CAD data to photograph data. Individual spare parts are identified on-the-fly from the CAD data. A user takes screenshots of a real assembly. The system identifies the position of the operator with respect to the assembly using the database. The CAD information may be overlaid onto the real object or image of the real object using rendering. Metadata may be exchanged between the 2.5D data and CAD.

In another embodiment, the object label is an annotation or other medical information. A scan of a patient is performed to acquire the 3D data. This scan is aligned with the 2.5D data from the camera and depth sensor 12. Depth information enables the registration of a mobile device viewing the patient to the medical volume data of the patient. This registration information can be used to trigger a cinematic render engine for overlaying. Annotations or other medical information added to or included in the 3D scan data are overlaid on a photograph or video of the patient. Skin or clothes segmentation or other image processing may be used to isolate information of interest in the 3D data for rendering onto the photograph. As the physician examines the patient visually, the augmentation is overlaid into the viewpoint of the physician.

FIG. 3 illustrates one embodiment of the system of FIG. 2. A database processor 40 (e.g., same or different type of processor as the image processor 16) generates orthographic projections 44 from 3D data 42 and/or an index 46 of the orthographic projections (e.g., values of deep-learnt features organized or not by similarity or clustering). The 3D data-based orthographic projections 44 provide depth information for each of different orientations and/or translations (e.g., 6-DOF) relative to the object. The index 46 and/or the orthographic projections 44 are stored in a database 48. The database 48 is populated at any time, such as days, weeks, or years prior to use for determining pose.

For use, the sensor 50 captures 2.5D data and converts the 2.5D data into an orthographic projection 52. The conversion may be selection of just the depth information. Using the index 46 as stored in the database 48, one or more matching orthographic projections 54 are found. The pose is determined from the matches. The pose may be filtered by a pose filter 56. The pose filter 56 refines the pose using the index, orthographic projections, and/or 3D data stored in the database 48.

FIG. 4 shows one embodiment of a method for matching depth information to 3D data. A camera viewpoint relative to an object is determined, allowing alignment of coordinate systems and/or transfer of metadata between data from different sources.

The method is implemented by the system of FIG. 2, the system of FIG. 3, or another system. For example, an RGBD sensor performs act 22. An image processor performs acts 24, 26, 28, and 30. The image processor and display perform act 32. As another example, a smart phone or tablet perform all the acts, such as using a perspective camera, image processor, and touch screen.

The method is performed in the order shown, but other orders may be used. Additional, different, or fewer acts may be provided. For example, acts for capturing 3D data, generating orthographic projections for different viewpoints from the 3D data, and indexing the orthographic projections (e.g., creating histograms of depth) are provided. As another example, act 24 is not performed where the distance measurements are used as the orthographic projection. In yet another example, acts 30 and/or 32 are not performed. In another example, acts 22 and 24 are not performed, but instead an already acquired orthographic projection is used in act 26.

In act 22, a camera acquires measurements of distance from a camera to an object. The camera includes a depth sensor for measuring the distances. The distance is from the camera to each of multiple locations on the object, such as locations represented by individual pixels or groups of pixels. In alternative embodiments, the depth measurements are acquired with a depth sensor without the camera function.

The user orients the camera at the object of interest from a given viewpoint. Any range to the object within the effective range of the depth measurements may be used. The user may activate augmented reality to initiate the remaining acts. Alternatively, the user activates an application for performing the remaining acts, activates the camera, or transmits a photograph or video with depth measurements to an application or service.

In act 24, an image processor orthographically projects the measurements of depth. Where the camera captures both pixel (e.g., photograph) and depth measurements, extracting or using the depth measurements provides the orthographic projection. Where just depth measurements are acquired, the measurements are used as the orthographic projection.

For matching in act 26, the orthographic projection may be compressed into a different representation. For example, the depth measurements are binned into a histogram. The histogram has any range of depths and/or number of bins. As another example, machine-learnt features are applied to the orthographic projection to determine values for the features.

In act 26, the image processor matches a representation of the orthographic projection from depth data of the depth sensor to one or more other representations of orthographic projections. The image processor may be on a mobile device with the camera or may be remote from the mobile device and camera.

The representations of the orthographic projections are the orthographic projections themselves or a compression of the orthographic projections. For example, depth histograms or values of machine-learnt features are matched.

The representation from the depth measurements is compared in act 28 to representations in a database. The representations in the database are created from 3D data of the object using bootstrapping and/or iterative testing to build an efficiently searchable database. The database may or may not include the 3D data, such as three-dimensional engineering data. The database may include reference representations as orthographic projections from the 3D data and/or index information and linked metadata for the poses.

The reference representations in the database are of the same object for which depth measurements were acquired in act 22, but from different viewpoints (e.g., orientations and/or translations) and a different data source. The references are generated from orthographic projections from known viewpoints, and the resulting database of reference representations are in a same coordinate system as the 3D data. The pose relative to the object in each of the references is known. Any number of references and corresponding viewpoints may be provided, such as tens, hundreds, or thousands.

Each representation in the database has a different pose relative to the object, so the comparison attempts to find representations with a same or similar pose as the pose of the camera to the object. The matching representation or representations from the database are found. Using the representations, the matches are found by comparing the orthographical projection of the measurements with orthographic projections from different views of the object.

The reference representations are searched to locate a match. The search finds a reference most similar to the query representation. Any measure of visual similarity may be used. For example, cross-correlation, sum of absolute differences, or nearest neighbor is used.

More than one match may be found. Alternatively, only a single match is found. The matching representation is found based on a threshold, such as a correlation or similarity threshold. Alternatively, other criterion or criteria may be used, such as finding the two, three, or more best matches.

To determine the pose in act 30, the representation form the depth measurements is matched with a viewpoint or viewpoints of reference orthographic projections. For a query set of depth measurements, a ranked list of similar viewpoints is generated by using comparison of representations of orthographic projections in the database. The matching determines the references with corresponding viewpoints (e.g., orientation and/or position) of the object most similar to the viewpoint of the query depth measurements. A ranked list or response map of similar views from the database is determined.

In act 30, the image processor determines a pose of an object relative to the depth sensor. This pose corresponds to the pose of the depth sensor relative to the reference 3D data. The camera viewpoint relative to the object is determined based on the comparisons and resulting matches. The determination is based on the representation from the depth measurements being matched to the representation of the orthographic projection from the 3D data. The orientation of the object relative to the depth sensor is calculated. Six or other number of degrees of freedom of the pose are determined. To transfer part-based labels from the 3D data to augment a view or overlay on a two-dimensional image, an accurate alignment of the representation from the depth measurements with respect to the 3D data is determined. The result is a viewpoint of the depth sensor and corresponding mobile device or user view to the object and corresponding 3D representation of the object.

Where more than one match is found, the poses of the matches may be combined. For example, the average orientation or an interpolation from multiple orientations is calculated. Alternatively, a voting scheme may be used.

Since quantized reference representations are used, the viewpoint for the best or top ranked matches may not be the same as the view point for the depth measurements. While the pose may be similar, the pose may not be the same. This coarse alignment may be sufficient.

Where more precise alignment is desired, the pose may be refined. More accurate registration is performed using the spatial distribution of the depths. To determine a finer pose, three or more points in the orthographic projection from the depth measurements are also located in the orthographic projection form the 3D data or in the 3D data of the matching representation or representations. The points may correspond to features distinguishable by depth variation, such as ridges or junctions. By adjusting the pose of the reference or references to different orientations, the similarities of the resulting features are compared to the features form the depth measurements. Any step size, search pattern, and/or stop criterion may be used. The refined or adjusted pose resulting in the best matching features is calculated as the final or refined pose.

In act 32, the image processor, using a display, augments an image. The augmentation is of an actual view of the object, such as by projecting the augmentation on a semi-transparent screen between the viewer and the object. In other embodiments, the augmentation is of an image displayed on a display, such as augmenting a photograph or video. For example, the display of the mobile device is augmented.

The image processor identifies information for the augmentation. The information is an object label. The label may identify a piece or part of the object, identify the object, provide non-geometric information, and/or provide a graphic of geometry for the object. The label has a position relative to the object, as represented by a location in the 3D data. Which of several labels to use may be determined based on user interaction, such as the user selecting a part of the object of interest and the label for that part being added.

The augmentation is a graphic, text, highlight, rendered image, or other addition to the view or another image. Any augmentation may be used. In one embodiment, the augmentation is a graphic or information positioned adjacent to or to appear to interact with the object rather than being over the object. The pose controls the positioning and/or the interaction.

The pose determined in act 30 indicates the position of the label location relative to the viewpoint by the camera. Each or any pixel of the image from the camera may be related to a given part of the object using the pose.

The label is transferred to the image. For example, in a segmentation embodiment, the label transfer converts labeled surfaces of the 3D data into annotated image regions of the viewed area in the photograph.

In one embodiment, the label transfer is performed by a look-up function. For each pixel from the photograph, the corresponding 3D point on the 3D data in the determined pose is found. The label for that 3D point is transferred to the two-dimensional location (e.g., pixel). By looking up the label from the 3D data, the part of the assembly or object shown at that location is identified or annotated.

In another embodiment, the 3D data is rendered. The rendering uses the determined pose or viewpoint. A surface rendering is used, such as an on-the-fly rendering with OpenGL or other rendering engine or language. The rendering may use only the visible surfaces. Alternatively, obstructed surfaces may be represented in the rendering. Only a sub-set of surfaces, such as one surface, may be rendered, such as based on user selection. By rendering, the object label is created as a mesh or rendering from the 3D data. The rendered pixels map to the pixels of the photograph. By combining the intensities from the 3D rendering and the photograph for each pixel, the augmentation is added. Any function for combining may be used.

As represented in FIGS. 2, 3, and/or 4, depth data is automatically matched to 3D data, such as CAD data. The correspondence between 2.5D depth images and 3D data is estimated. The matching recovers the pose for the 2.5D depth data with respect to the 3D data. The pose supports fusion of the involved modalities within a common metric coordinate system. Fusion enables the linkage of spatially related data within involved modalities since the 2D/3D correspondences on image, object and pixel level are found.

To find the correspondences between the 3D modality (3D data) and depth streams (2.5D images), orthographic projections of the 3D data are generated from potential viewpoints. These orthographic projections may be represented as 2.5D data structures. Using these orthographic projections normalized to a pixel size is invariant to camera parameters. The 3D data (e.g., CAD, GIS, engineering, or medical) may be in a metric format. The depth sensing devices (e.g., RGBD sensing) provide metric measurements. The orthographic representations may be normalized for pixel size, which is derived from sensor specifications.

To speed the search for real-time or video augmentation, an indexing system finds potentially relevant projections to the current scene observation. The indexing uses image representations, reducing computation costs during pose estimation. Potential 2.5D projections are used within a filter using the orthographic projections. Knowledge of scale and the computed response map from comparison determines the final pose of the camera.

In an embodiment where the camera is an orthographic 3D camera, the mapping from perspective to orthographic data is not needed. Instead, the orthographic projection is provided directly as an output of the camera.

Various improvements described herein may be used together or separately. Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

What is claimed is:

1. A system for matching depth information to 3D information, the system comprising:
a depth sensor (12) for sensing 2.5D data representing an area of an object facing the depth sensor (12) and depth from the depth sensor (12) to the object for each location of the area;
a memory (18) configured to store a database (48) of entries representing the object from respective poses, the entries populated in the database (48) by iterative test of first matches of samples to the entries and adding the samples without matches as entries;
an image processor (16) configured to search the entries of the database (48) for a second match and to transfer an object label to a coordinate system of the depth sensor (12) based on the second match; and
a display (20) configured to display an image from the 2.5D data augmented with the object label.

2. The system of claim 1 wherein the depth sensor (12) comprises a depth sensor (12) using structured light, time-of-flight, or lidar, and wherein the 2.5 data comprises a camera image for the area and the depth from the structured light, time-of-flight, or lidar.

3. The system of claim 1 wherein the 2.5D data represents a surface of the object viewable from the depth sensor (12).

4. The system of claim 1 wherein the database entries are populated by random population of a first set of the entries, and random generation of a first set of the samples.

5. The system of claim 1 wherein a database processor (40) is configured to generate an image representation for each of the entries and samples and wherein the test of the first matches comprises testing based on the image representations.

6. The system of claim 5 wherein the image representations are features determined by a deep-learnt machine classifier.

7. The system of claim 1 wherein the iterative test comprises test of the first matches for different samples in each iteration with a stop criterion based on a measure of coverage.

8. The system of claim 1 wherein the image processor (16) is configured to perform the search using a tree structure.

9. The system of claim 1 wherein the image processor (16) is configured to perform the search using a nearest neighbor matching.

10. A method for creating a database (48) for pose estimation from a depth sensor (12), the method comprising:
sampling (60) a first plurality of poses of the depth sensor (12) relative to a representation of an object;
assigning (62) the poses of the first plurality to the database (48);
sampling (60) a second plurality of poses of the depth sensor (12) relative to the representation of the object;
finding (70) nearest neighbors of the poses of the database (48) with the poses of the second plurality;
assigning (62) the poses of the second plurality to the database (48) where the nearest neighbors are farther than a threshold and not assigning (62) the poses of the second plurality to the database (48) where the nearest neighbors are closer than the threshold; and
repeating the sampling (60) with a third plurality of poses, finding (70) the nearest neighbors with the poses of the third plurality, and assigning (62) the poses of the third plurality based on the threshold.

11. The method of claim 10 further comprising repeating the repeating with a fourth plurality of poses.

12. The method of claim 10 further comprising:
determining (74) a coverage of the database (48) based on a ratio of a number of the poses of the third plurality assigned to the database (48) to a number of the poses of the third plurality.

13. The method of claim 12 further comprising ceasing based on the coverage.

14. The method of claim 10 wherein sampling (60) the first, second, and third pluralities comprise random sampling (60).

15. The method of claim 10 further comprising:
Generating (68) image representations of the object at the poses of the first and second pluralities, the image representations comprising machine-learnt features;
wherein finding (70) comprises finding (70) as a function of the image representations.

16. The method of claim 10 wherein finding (70) comprises finding (70) with a tree search through the database (48).

17. A method for creating a database (48) for pose estimation from a depth sensor (12), the method comprising:
selecting (66) a first plurality of different camera poses relative to an object;
rendering (68) depth images of the object at the different camera poses of the first plurality;
assigning (62) the different camera poses of the first plurality to a database (48); and
adding (72) additional camera poses in a bootstrapping aggregation (64) comparing (70) depth images of the additional camera poses to the depth images of the camera poses of the database (48), the adding (72) occurring when the comparing (70) indicates underrepresentation in the database (48).

18. The method of claim 17 wherein selecting (66) comprises randomly selecting (66), and wherein adding (72) comprises randomly selecting the additional camera poses for the comparing.

19. The method of claim 17 further comprising not adding when the comparing (70) indicates representation in the database (48).

20. The method of claim 17 wherein comparing (70) is performed iteratively with a stop criterion based on coverage of poses of the object in the database (48).
